(19) United States
(12) Patent Application Publication
(10) Pub. No.: US 2026/0012468 A1
(43) Pub. Date: Jan. 8, 2026

(54) BOTNET DETECTION USING TRANSFORMER-BASED EMBEDDINGS AND SIMILARITY SEARCH

(71) Applicant: UNIVERSITY OF SOUTH FLORIDA, Tampa, FL (US)

(72) Inventors: Xinming OU, Tampa, FL (US); Kumar SHASHWAT, Tampa, FL (US); Francis HAHN, Tampa, FL (US); Stuart MILLAR, Belfast (GB)

(21) Appl. No.: 19/260,245

(22) Filed: Jul. 3, 2025

Related U.S. Application Data
(60) Provisional application No. 63/667,512, filed on Jul. 3, 2024.

(51) Int. Cl. H04L 9/40

(52) U.S. Cl. CPC H04L 63/1416

(57) ABSTRACT

A method for classifying a digital certificate as malicious or non-malicious includes receiving the digital certificate from a network source and extracting textual fields from the certificate. The extracted text is embedded into a high-dimensional vector using a pretrained transformer-based encoder. The resulting test vector is queried against a vector data structure populated with reference vectors derived from known benign and malicious certificates. A similarity search is performed to identify a set of nearest reference vectors. A classification decision is made based on the labels of the most similar/nearest neighbors, using a voting mechanism. If a given set or number of them are labeled as malicious, the certificate is classified as malicious. If not, it is classified as benign. The classification result may trigger a network security action, such as blacklisting the associated IP address or identifying a botnet command and control server. The system may use various embedding techniques, including concatenating subject and issuer fields or embedding individual certificate attributes separately.

### CROSS-REFERENCE TO RELATED APPLICATION(S)

This application claims priority to U.S. Provisional Patent Application No. 63/667,512 filed on Jul. 3, 2024, the entire contents of which are incorporated herein by reference for all purposes.

### BACKGROUND

Botnets are distributed networks of compromised computing devices controlled by malicious actors to execute coordinated cyberattacks. These devices, often referred to as bots, communicate with a command and control (C&C) server, enabling remote orchestration of activities such as distributed denial-of-service (DDOS) attacks, credential theft, and data exfiltration. A common tactic employed by botnets to evade detection is the use of Transport Layer Security (TLS) encryption, which conceals the content of communications from traditional network monitoring tools. During the TLS handshake, the server presents an x.509 certificate, which, while intended to establish trust, may be syntactically valid yet semantically anomalous in malicious contexts.

Traditional botnet detection techniques fall into two primary categories: signature-based and anomaly-based. Signature-based methods rely on known patterns and indicators of compromise, offering high precision but limited adaptability to novel threats. Anomaly-based approaches, often leveraging machine learning, provide broader detection capabilities but are prone to higher false positive rates.

### SUMMARY

In some aspects, the techniques described herein relate to a method of evaluating a digital certificate, including: receiving the digital certificate from a network source; extracting text from the digital certificate; performing a vector embedding for the extracted text using a pretrained transformer-based encoder to generate a test vector; searching a vector data structure using the test vector to identify a reference vector; and classifying the digital certificate as malicious or non-malicious based on the reference vector.

In some aspects, the techniques described herein relate to a method, further including: identifying a botnet command and control server associated with the digital certificate in response to classifying the digital certificate as malicious.

In some aspects, the techniques described herein relate to a method, further including: populating a blacklist with a source or destination network address associated with the digital certificate in response to classifying the digital certificate as malicious.

In some aspects, the techniques described herein relate to a method, wherein performing the vector embedding comprises generating a single embedding vector from a subject string of the digital certificate.

In some aspects, the techniques described herein relate to a method, wherein performing the vector embedding comprises: concatenating a subject string and an issuer string of the digital certificate into an input string; and generating an embedding vector from the input string.

In some aspects, the techniques described herein relate to a method, wherein performing the vector embedding comprises: generating separate embedding vectors for a subject string and an issuer string of the digital certificate; and concatenating the separate embedding vectors to form the test vector.

In some aspects, the techniques described herein relate to a method, wherein performing the vector embedding comprises: generating individual embedding vectors for each of a plurality of parsed features from the subject and issuer fields of the digital certificate; and concatenating the individual embedding vectors to form the test vector.

In some aspects, the techniques described herein relate to a method, wherein classifying the digital certificate comprises identifying a plurality of k nearest reference vectors to the test vector in the vector data structure, and determining the classification based on a majority vote among the classifications of the k nearest reference vectors.

In some aspects, the techniques described herein relate to a method, wherein the vector data structure comprises a vector index implemented using a similarity search engine for approximate nearest neighbor retrieval.

In some aspects, the techniques described herein relate to a network monitoring system for evaluating a digital certificate, including: a computer-readable medium storing code that, when executed by a processor, causes the processor to perform the method of evaluating a digital certificate as described above.

In some aspects, the techniques described herein relate to a non-transitory computer-readable medium storing executable instructions to: receive a digital certificate from a network source; extract text from the digital certificate; perform a vector embedding for the extracted text using a pretrained transformer-based encoder to generate a test vector; search a vector data structure using the test vector to identify a reference vector; and classify the digital certificate as malicious or non-malicious based on the reference vector.

### BRIEF DESCRIPTION OF THE DRAWINGS

To describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings.

FIG. 1 illustrates an example network environment in which a system for detecting botnet activity using TLS certificate analysis may be deployed.

FIG. 2 illustrates an example computing architecture for evaluating a digital certificate using transformer-based vector embeddings and similarity search.

FIG. 3 illustrates an example method for classifying a digital certificate as malicious or non-malicious using a pretrained transformer-based encoder and a vector similarity search engine.

FIG. 4 illustrates an example overview for classifying the digital certificates as malicious or non-malicious in one or more stages.

FIG. 5 illustrates an example of one or more embeddings made into a final embedding vector.

FIG. 6 illustrates an example of a test certificate being queries against one or more known malicious and non-malicious certificates projected in a 2D embedding space.

Before explaining the disclosed embodiment of this disclosure in detail, it is to be understood that the invention is not limited in its application to the details of the particular arrangement shown, as the invention is capable of other embodiments. Example embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

While the subject disclosure applies to embodiments in many different forms, there are shown in the drawings and will be described in detail herein specific embodiments with the understanding that the present disclosure is an example of the principles of the invention. It is not intended to limit the invention to the specific illustrated embodiments. The features of the invention disclosed herein in the description, drawings, and claims can be significant, both individually and in any desired combinations, for the operation of the invention in its various embodiments. Features from one embodiment can be used in other embodiments of the invention. In the description of the drawings, unless explicitly stated otherwise, like reference numerals refer to like elements.

Botnets-distributed networks of compromised computing devices-pose a persistent and evolving threat to modern digital infrastructure. These networks, orchestrated by malicious actors through command and control (C&C) servers, are capable of executing a wide range of cyberattacks, including distributed denial-of-service (DDOS), credential theft, and data exfiltration. To evade detection, botnets increasingly rely on Transport Layer Security (TLS) encryption, which conceals the content of communications from traditional network monitoring tools. During the TLS handshake, the server presents an x.509 certificate, which, while syntactically valid, may exhibit semantic anomalies indicative of malicious intent.

Traditional botnet detection techniques fall into two primary categories: signature-based and anomaly-based. Signature-based methods offer high precision but are limited in their ability to detect novel threats. Anomaly-based approaches, often leveraging machine learning, provide broader detection capabilities but suffer from high false positive rates and require extensive feature engineering or model retraining. These limitations hinder their scalability and adaptability in production environments, particularly when dealing with the high volume and velocity of TLS traffic in enterprise and cloud-native networks.

The time-sensitive nature of botnet communications, especially those involving ephemeral TLS certificates, necessitates a detection mechanism that is both accurate and computationally efficient. Security analysts cannot feasibly inspect every certificate manually, and existing automated systems struggle to keep pace with the dynamic and evasive behaviors of modern botnets. Moreover, the increasing adoption of TLS across all layers of the network stack further complicates visibility, making it imperative to develop detection techniques that operate effectively without decrypting traffic.

The disclosed technology addresses these challenges by introducing a system and method for classifying digital certificates as malicious or non-malicious using pretrained transformer-based language models and high-dimensional vector similarity search. Unlike prior approaches that require training complex models from scratch, the disclosed technology leverages existing large language models (LLMs) to generate vector embeddings from textual fields of TLS certificates—such as subject and issuer attributes—and compares them against a curated vector index of known benign and malicious certificates.

This embedding-based approach enables fast, scalable, and accurate classification of TLS certificates, even in zero-day scenarios where the certificate has not been previously observed. The disclosed technology supports multiple embedding strategies, including concatenation of subject and issuer fields, separate embeddings for each field, and fine-grained embeddings for individual certificate attributes. The resulting test vector is queried against a vector data structure—such as FAISS or Milvus—using approximate nearest neighbor search to identify similar reference vectors. A classification decision is made based on a voting mechanism among the nearest neighbors, and the result may trigger automated network security actions, such as blacklisting or alerting a security information and event management (SIEM) platform.

The disclosed technology provides a lightweight, vendor-agnostic, and production-ready solution for botnet detection in encrypted environments. It significantly reduces the human effort required to identify malicious infrastructure, as demonstrated by evaluations on real-world TLS certificate datasets, including those collected from internet-wide scans. The system achieves high classification accuracy with minimal inference latency, making it suitable for deployment in edge devices, enterprise firewalls, and cloud-native monitoring platforms.

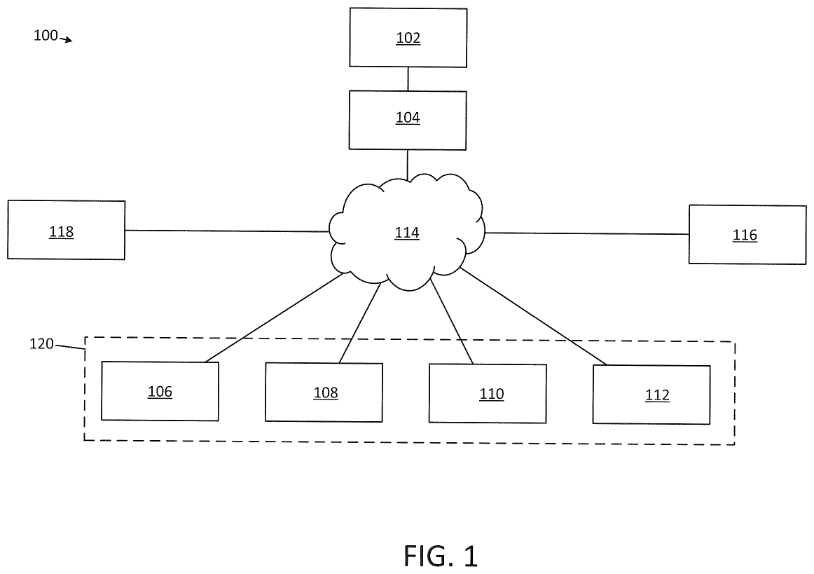

FIG. 1 illustrates an example network environment 100 in which a system and method for detecting botnet activity may be implemented. The network environment 100 may comprise a plurality of interconnected computing devices, including, for example, a malicious actor device 102, a botnet command and control (C&C) server 104, a plurality of compromised devices 106, 108, 110, and 112 forming a botnet 120, a target system 116, and a network monitoring device 118.

The malicious actor device 102 may be any computing device under the control of an adversary, such as a laptop, virtual machine, or cloud-hosted instance. The device 102 may be configured to initiate and coordinate malicious activity via the C&C server 104. The C&C server 104 may be implemented as a remote server, virtual private server (VPS), or cloud-based endpoint, and may be responsible for issuing instructions to the botnet 120.

The botnet 120 may comprise a collection of compromised devices 106-112, which may include, for instance, personal computers, Internet of Things (IoT) devices, mobile phones, or other internet-connected endpoints. These devices may be geographically distributed and connected via public or private networks. Each compromised device may be configured to receive and execute commands from the C&C server 104. Such commands may include, but are not limited to, distributed denial-of-service (DDOS) attacks, data exfiltration, credential harvesting, or lateral movement within a target network.

Botnets may employ sophisticated evasion techniques to conceal their C&C communications. One prevalent method may involve the use of Transport Layer Security (TLS) encryption, which may render the content of network traffic opaque to traditional inspection tools. During the TLS handshake, the C&C server may present an x.509 certificate to establish its identity. While these certificates are intended to signal trust, malicious actors may generate or reuse certificates with subtle anomalies—such as randomized subject fields, non-standard issuer names, or syntactically valid but semantically meaningless attribute values—to avoid detection while maintaining protocol compliance.

In many cases, botnet operators may use self-signed certificates or certificates issued by compromised or misconfigured certificate authorities. Some botnets may rotate certificates frequently or use domain generation algorithms (DGAs) to associate new domains with fresh certificates, further complicating detection. These behaviors may result in a long tail of low-reputation or anomalous certificates that, while individually innocuous, collectively form a fingerprintable pattern of malicious infrastructure.

The disclosed system may leverage these patterns by extracting and embedding structural and semantic features from TLS certificates, thereby enabling classification of botnet-related activity without requiring decryption of the underlying traffic.

The target system 116 may represent a computing resource or system that is the intended recipient of malicious activity. In various implementations, the target 116 may include, for example, enterprise web servers, cloud-hosted applications, financial transaction systems, industrial control systems (ICS), or public-facing application programming interfaces (APIs). Botnets may target these systems to achieve objectives such as service disruption, data theft, or unauthorized access to sensitive infrastructure.

For example, a botnet may launch a DDOS attack against a financial institution's online banking platform to disrupt customer access and extort ransom payments. In another scenario, a botnet may be used to exfiltrate intellectual property from a corporate file server or to harvest credentials from a customer authentication portal. Industrial systems, such as those used in energy or manufacturing sectors, may be targeted to cause operational disruption or to serve as entry points for broader cyber-physical attacks. Public cloud services and content delivery networks (CDNs) may also be targeted to amplify attacks or to exploit trusted infrastructure for further propagation.

The network monitoring device 118 may be deployed within the network 100 and may be configured to detect botnet-related communications, particularly those encrypted using the TLS protocol. In some implementations, the network monitoring device 118 may be deployed at a network ingress or egress point, such as a firewall, router, or gateway, or may be integrated into a cloud-based traffic inspection service.

Examples of such devices may include intrusion detection systems (IDS) and intrusion prevention systems (IPS), such as Snort, Suricata, or Zeek, which may be configured to inspect TLS handshake metadata and extract certificate fields for analysis. In enterprise environments, the network monitoring device 118 may be implemented as a dedicated appliance or virtualized sensor running on a hypervisor, capable of mirroring traffic from a network tap or switch span port. In cloud-native deployments, the monitoring functionality may be embedded within service meshes or sidecar proxies, such as Envoy, to observe encrypted traffic between microservices.

Some implementations may leverage next-generation firewalls (NGFWs) with deep packet inspection (DPI) capabilities to extract TLS metadata without decrypting payloads. Additionally, security information and event management (SIEM) platforms, such as Splunk or IBM QRadar, may ingest telemetry from distributed sensors and apply the described embedding-based classification pipeline as part of a broader threat detection strategy. In high-throughput environments, the network monitoring device 118 may be accelerated using field-programmable gate arrays (FPGAs) or application-specific integrated circuits (ASICs) to perform real-time feature extraction and vector embedding at line rate.

In one embodiment, the network monitoring device 118 may be configured to intercept TLS handshake packets and extract the x.509 certificate presented by the server. The system may parse the certificate to extract the subject and issuer fields, and may optionally decompose these into subfields such as Common Name (CN), Organization (O), Organizational Unit (OU), Country (C), State (ST), Locality (L), and Email address. Missing fields may be imputed with a placeholder string (e.g., “NA”) to ensure consistent input formatting.

These fields may then be tokenized and passed through a text embedding model, such as a character-level transformer or sentence encoder, to generate a fixed-length vector representation. Depending on the configuration, the system may employ one of several embedding strategies. For example, the system may embed the concatenated subject and issuer string; embed subject and issuer separately and concatenate the resulting vectors; or embed each subfield individually and concatenate all resulting vectors. The number of subfields may range, for instance, from 2 to 14, depending on certificate structure and implementation. The resulting embedding vector may have a dimensionality ranging, for example, from approximately 768 to 6,144, depending on the embedding model used.

In some implementations, the system may support multiple embedding strategies, including: (i) embedding the subject string alone; (ii) concatenating the subject and issuer strings into a single input and generating a unified embedding; (iii) embedding the subject and issuer strings separately and concatenating the resulting vectors; and (iv) embedding each parsed subfield individually and concatenating the resulting vectors. These strategies may be selected based on performance, inference time, and model compatibility. For example, strategy (iii) has demonstrated high classification accuracy while maintaining computational efficiency 1.

The embedding model may be selected from a set of pretrained large language models (LLMs), including open-source and commercial offerings. Examples include BERT, C-BERT, OpenAI's text-embedding-3-large, AWS Titan, Cohere, and VoyageAI. Each model may produce embeddings of varying dimensionality, and may be selected based on trade-offs between inference latency, classification performance, and deployment constraints. In one embodiment, a character-level model such as C-BERT may be used to capture fine-grained semantic patterns in short certificate fields 1.

The extracted certificate attributes may be preprocessed and transformed into high-dimensional vector embeddings using one or more embedding techniques. These techniques may include, for instance, methods employed in natural language processing systems, such as character-level or token-level embedding models.

The system includes a vector database component configured to store and retrieve high-dimensional embeddings derived from TLS certificate metadata. In one embodiment, the vector database is implemented using FAISS (Facebook AI Similarity Search), which supports multiple indexing strategies, such as flat (brute-force) indices for exact search, inverted file (IVF) indices for partitioned approximate search, product quantization (PQ) for compressed vector representations, optimized product quantization (OPQ) for improved quantization accuracy, and hierarchical navigable small world (HNSW) graphs for graph-based search. These indexing strategies may be selected, for example, based on dataset size, update frequency, and available hardware resources.

The FAISS index may be configured to operate on CPU or GPU, and may support sharding across multiple processing units. In some implementations, the system maintains multiple FAISS indices with different configurations, such as one index optimized for low-latency queries and another for high-recall retrieval. The system may also support dynamic reconfiguration of the index, including, for instance, re-quantization of vectors or rebalancing of clusters. In distributed deployments, the FAISS index may be partitioned across nodes and queried using a fan-out and merge strategy. The FAISS library may be compiled with support for hardware-specific instruction sets, such as AVX2 or CUDA, depending on the deployment environment.

In alternative embodiments, the vector database may be implemented using other technologies, such as Milvus, Weaviate, Qdrant, Pinecone, Vespa, Annoy, ScaNN, or NMSLIB. For example, Milvus may support hybrid vector and scalar filtering; Weaviate may provide a semantic schema and GraphQL interface; Qdrant may support HNSW indexing with payload filtering; Pinecone may support namespace isolation and metadata filtering; Vespa may support integrated ranking and filtering; Annoy may support static memory-mapped indices; ScaNN may support asymmetric hashing and tree-structured quantization; and NMSLIB may support a variety of distance functions and indexing algorithms including VP-trees and SW-graphs.

The vector database is integrated with the embedding pipeline and classification logic. Embeddings may be stored, for instance, in floating-point format, with dimensionality ranging from 768 to 6,144 depending on the embedding model. The database may support batch insertion, deletion, and re-indexing operations. Query interfaces may expose parameters such as top-k, distance threshold, and filtering criteria. During inference, the system generates an embedding for a test certificate and queries the vector database to retrieve the k-nearest neighbors, where k may be, for example, between 1 and 10. The classification decision may be based on the labels of the retrieved neighbors, using either majority voting or a weighted scoring function.

The vector database may be updated periodically to incorporate newly labeled certificates. Updates may be performed incrementally or through full re-indexing. In some configurations, the system supports real-time querying as part of a streaming analytics pipeline. In other configurations, the system supports batch querying for retrospective analysis of historical TLS traffic. The vector database may also be used to support auxiliary functions such as clustering, anomaly detection, or similarity-based threat attribution, depending on the operational context.

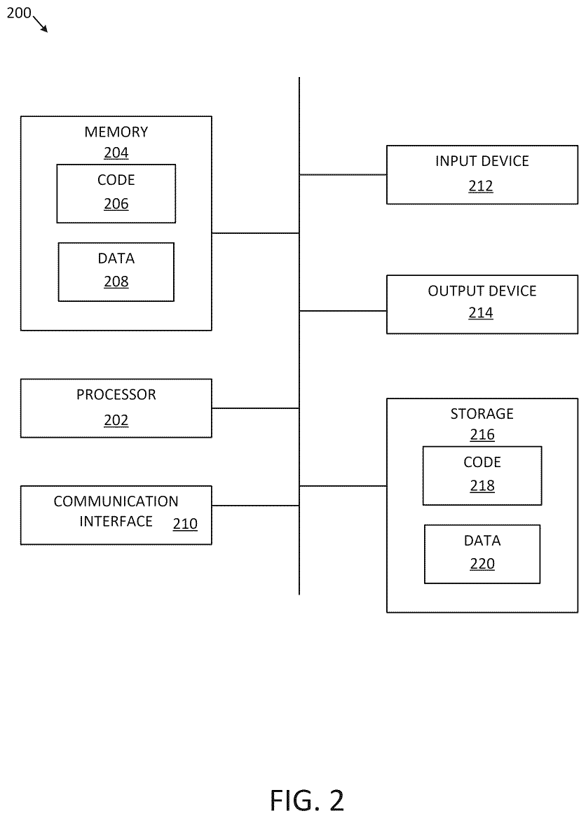

FIG. 2 illustrates an example computing architecture 200 that may implement a network monitoring device, such as the network monitoring device 118 described with reference to FIG. 1. The architecture 200 may include a processor 202, memory 204, storage 206, communication interface 208, input device 210, output device 212, and a system bus 214. These components may be interconnected via the system bus 214 or other suitable interconnects.

The processor 202 may comprise one or more processing units configured to execute instructions stored in the memory 204 and/or the storage 206. The processor 202 may be implemented using general-purpose central processing units (CPUs), graphics processing units (GPUs), application-specific integrated circuits (ASICs), field-programmable gate arrays (FPGAs), or any combination thereof. In some embodiments, the processor 202 may include a GPU cluster configured to execute transformer-based models compiled using the Open Neural Network Exchange (ONNX) format. In other embodiments, the processor 202 may include an ARM-based system-on-chip (SoC) incorporating a neural processing unit (NPU) optimized for transformer inference.

The memory 204 may include volatile and/or non-volatile memory components, such as dynamic random-access memory (DRAM), static RAM (SRAM), EEPROM, or LPDDR5. The memory 204 may store executable code 216 and runtime data 218. The executable code 216 may include instructions that, when executed by the processor 202, cause the processor to perform vector embedding operations on digital certificate data. The code 216 may include logic for generating a single embedding vector from a subject string of a digital certificate, for generating an embedding vector from a concatenated subject and issuer string, and for generating separate embedding vectors for subject and issuer strings and concatenating them to form a test vector. In some embodiments, the code 216 may include logic for generating individual embedding vectors for parsed certificate fields, such as Common Name (CN), Organization (O), Organizational Unit (OU), Country (C), State (ST), Locality (L), and Email address, and for concatenating those vectors into a high-dimensional test vector. The runtime data 218 may include intermediate representations of certificate fields, embedding vectors, and other data structures used during inference and classification.

The storage 206 may include one or more persistent storage devices, such as NVMe solid-state drives (SSDs), SATA drives, or distributed object stores. The storage 206 may store executable code 220 and data 222. The executable code 220 may include instructions that, when executed by the processor 202, cause the processor to perform similarity search and classification operations. The data 222 may include a vector database comprising reference vectors corresponding to known malicious and benign certificates. The vector database may be implemented using a similarity search engine configured for approximate nearest neighbor (ANN) retrieval. In various embodiments, the vector database may be implemented using FAISS with a Hierarchical Navigable Small World (HNSW) index, Milvus with IVF-PQ indexing, or other ANN indexing engines. The vector database may be stored in a local file system, a memory-mapped index, or a dedicated vector database engine. In some implementations, the vector database may be loaded into RAM or GPU memory to enable low-latency access. The storage 206 may further include logic for inserting new reference vectors, deleting outdated entries, and re-indexing the vector database.

In some embodiments, the storage 206 may be distributed and located remotely from the processor 202 and memory 204. For example, the vector database and associated code may reside on a network-attached storage (NAS) device, a storage area network (SAN), or a distributed object store accessible over a network. In such configurations, the processor 202 may access the storage 206 via the communication interface 208 using protocols such as NFS, SMB, ISCSI, or S3.

The system bus 214 may include one or more interconnects, such as PCI Express (PCIe), Advanced extensible Interface (AXI), or custom buses, configured to facilitate high-speed communication among the processor 202, memory 204, storage 206, and I/O components. The architecture 200 may be implemented as a monolithic appliance, a containerized microservice deployment, or a hybrid configuration. In virtualized environments, the components of architecture 200 may be deployed as containers orchestrated by platforms such as Kubernetes. In other embodiments, the architecture 200 may be embedded in a single-purpose appliance with hardened firmware and secure boot.

The architecture 200 may be configured for real-time streaming, batch processing, or hybrid operation. In a real-time configuration, the processor 202 may generate embeddings and perform classification at line rate, with the vector database residing in GPU memory. In a batch configuration, the processor 202 may analyze historical TLS traffic logs. In a hybrid configuration, the processor 202 may perform initial classification locally and transmit ambiguous cases to a centralized backend for further analysis.

The classification logic implemented by the code 220 may include instructions for identifying a plurality of k-nearest reference vectors to a test vector in the vector database and for determining a classification of the test vector based on one or more decision strategies. In one embodiment, the classification logic may implement a majority voting scheme, wherein each of the k-nearest reference vectors contributes a single vote corresponding to its associated class label, and the class label receiving the highest number of votes is assigned to the test vector.

In another embodiment, the classification logic may implement a weighted voting scheme. In such an embodiment, each of the k-nearest reference vectors may be associated with a similarity score, such as a cosine similarity or inverse Euclidean distance, relative to the test vector. The classification logic may compute a weighted sum of votes for each class label, wherein the weight of each vote is proportional to the similarity score of the corresponding reference vector. The class label with the highest cumulative weighted score may be assigned to the test vector.

In a further embodiment, the classification logic may implement a distance-thresholding strategy. In this embodiment, the classification logic may compare the similarity scores of the k-nearest reference vectors to a predefined threshold. If a sufficient number of reference vectors within the threshold are associated with a particular class label, the test vector may be assigned that label. If the similarity scores fall below the threshold or the class distribution is ambiguous, the classification logic may assign a default label, such as “unknown,” or may defer classification to a secondary system.

In another embodiment, the classification logic may implement a probabilistic inference model. For example, the classification logic may apply a softmax function to the similarity scores of the k-nearest reference vectors to produce a probability distribution over possible class labels. The test vector may then be assigned the class label with the highest probability, or the full distribution may be used to inform downstream decision-making processes.

In yet another embodiment, the classification logic may implement a clustering-based approach. In such an embodiment, the vector database may be pre-processed using an unsupervised clustering algorithm, such as k-means or DBSCAN, to form clusters of reference vectors. Each cluster may be associated with a dominant class label. The classification logic may assign the test vector to the nearest cluster and may assign the corresponding dominant label to the test vector.

The vector database stored in the storage 206 may be constructed using a variety of methods, depending on the availability of labeled data, the intended deployment environment, and the desired balance between precision and coverage. In one embodiment, the vector database may be populated using embeddings generated from a curated corpus of known malicious and benign TLS certificates. For example, the system may ingest certificates from publicly available threat intelligence feeds such as the SSL Blacklist (SSLBL), which provides labeled botnet command-and-control (C&C) certificates, and combine them with certificates from high-reputation sources such as the Alexa Top 1 Million domains to form a balanced reference set. In another embodiment, the vector database may be constructed using certificates collected through active scanning of the public internet, wherein the system may extract x.509 certificates from TLS handshakes initiated against a broad IP address space and apply offline labeling heuristics or third-party validation services (e.g., VirusTotal) to assign ground truth labels.

In some implementations, the vector database may be built using telemetry collected from enterprise network infrastructure. For example, the system may extract certificates observed in TLS sessions traversing a firewall, proxy, or intrusion detection system (IDS), and may label those certificates based on correlation with known indicators of compromise (IOCs), behavioral analytics, or analyst review. In other implementations, the vector database may be derived from historical incident response data, wherein certificates associated with confirmed security events are embedded and stored as labeled reference vectors. The system may also support semi-supervised or unsupervised construction of the vector database, wherein embeddings are generated from unlabeled certificates and clustered using techniques such as k-means or DBSCAN, and cluster labels are assigned based on proximity to known malicious or benign exemplars.

The vector database may be periodically updated to reflect emerging threats and evolving infrastructure. For example, the system may implement a scheduled ingestion pipeline that retrieves new certificate samples from honeypots, sinkholes, or passive DNS datasets, generates embeddings using the same strategy as the original reference set, and appends the resulting vectors to the database. In some embodiments, the system may support incremental re-indexing or full re-quantization of the vector database to maintain search performance and accuracy as the dataset grows. The system may also implement deduplication logic to avoid storing redundant embeddings and may track metadata such as collection timestamp, source, and labeling confidence for each reference vector.

The vector database may implement hybrid filtering techniques that combine vector similarity with additional filtering criteria to improve classification accuracy and operational efficiency. In one embodiment, the vector database may implement vector-scalar filtering, wherein high-dimensional vector similarity search is combined with scalar attribute filtering based on metadata fields such as certificate issuer, country code, or certificate validity period. In another embodiment, the vector database may implement namespace-based filtering, wherein reference vectors are partitioned into logical namespaces (e.g., by customer, region, or deployment zone), and similarity search is restricted to a selected namespace. In a further embodiment, the vector database may implement tag-based filtering, wherein reference vectors are annotated with one or more tags representing contextual attributes, and similarity search is constrained to vectors matching a specified tag set. In yet another embodiment, the vector database may implement time-window filtering, wherein only reference vectors associated with a timestamp falling within a specified temporal window are considered during similarity search. In some implementations, the vector database may implement compound filtering strategies that combine two or more of the above techniques, such as performing similarity search within a namespace-constrained and time-bounded subset of vectors that also satisfy scalar metadata conditions. These hybrid filtering techniques may be implemented using vector database engines that support advanced query composition, such as Weaviate, Qdrant, or Vespa. The communication interface 208 may include hardware and software components configured to receive digital certificates from external sources. The communication interface 208 may implement physical and logical interfaces for Ethernet, Wi-Fi, 5G, or satellite links, and may support protocols including TCP/IP, gRPC, MQTT, and REST. The communication interface 208 may implement mechanisms for receiving certificate metadata from passive monitoring of TLS handshakes, ingestion of telemetry from distributed sensors, and retrieval of certificate logs from cloud services. In cloud-native deployments, the communication interface 208 may implement a RESTful API for receiving certificate metadata from a Kubernetes sidecar proxy. In enterprise deployments, the communication interface 208 may implement packet capture interfaces for extracting certificates from mirrored network traffic.

The input device 210 may include one or more interfaces for receiving user input or external system commands. The input device 210 may include a touchscreen, keyboard, or API endpoint configured to receive digital certificates for evaluation. The output device 212 may include one or more interfaces for presenting classification results or system status. The output device 212 may include a display, indicator lights, or other visual or auditory output mechanisms. The output device 212 may be configured to display log files, dashboards, or alerts generated by the processor 202.

In some embodiments, the processor 202 may be configured to transmit classification results, alerts, or metadata to an external security information and event management (SIEM) platform via the communication interface 208. The communication interface 208 may implement outbound connectors or webhook endpoints for integration with SIEM platforms such as Splunk, IBM QRadar, Elastic Security, or Microsoft Sentinel. The processor 202 may format classification results as structured log messages or JSON payloads conforming to the Common Event Format (CEF), Log Event Extended Format (LEEF), or other SIEM-compatible schemas. These messages may include fields such as certificate fingerprint, classification label, similarity score, timestamp, source IP address, and embedding strategy identifier. In some implementations, the processor 202 may enqueue classification events into a message broker or event bus, such as Apache Kafka or Azure Event Hubs, which may be subscribed to by the SIEM platform for real-time ingestion. In other implementations, the processor 202 may expose a RESTful API endpoint that allows the SIEM platform to poll for new classification results or query historical decisions. The system may further include logic for tagging or enriching classification events with contextual metadata, such as threat intelligence indicators, geolocation data, or asset inventory references, prior to transmission to the SIEM.

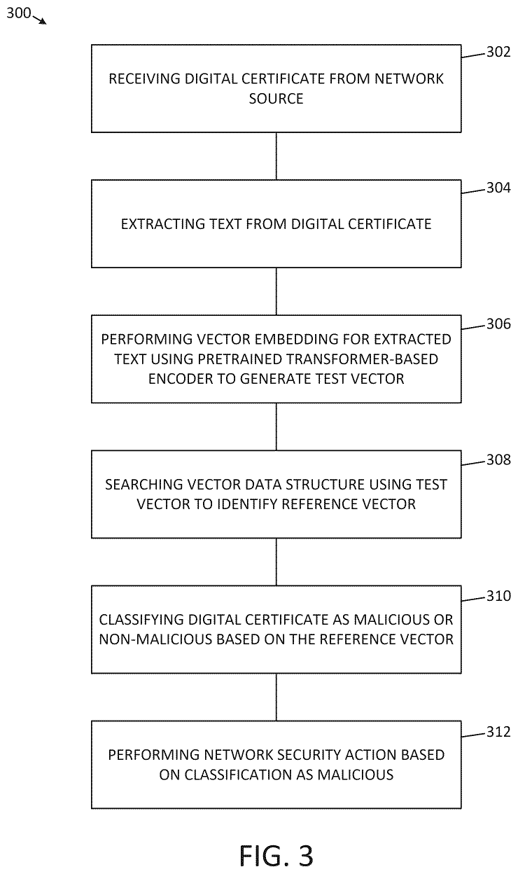

FIG. 3 illustrates an example method 300 for evaluating a digital certificate using transformer-based vector embeddings and similarity search. The method 300 may be implemented by a network monitoring system, such as the system architecture described with reference to FIG. 2, and may be executed by one or more processors configured to perform the operations shown. In some embodiments, the method 300 may be performed in real-time, near-real-time, or batch processing modes. The method may be deployed in a variety of environments, including but not limited to cloud-native platforms, enterprise networks, edge computing devices, or embedded security appliances.

At block 302, the system may receive a digital certificate from a network source. The digital certificate may be received during a Transport Layer Security (TLS) handshake, extracted from a certificate transparency log, or obtained from telemetry feeds, passive network taps, or active scanning infrastructure. The certificate may be received in any suitable format, including but not limited to DER, PEM, or base64-encoded representations. In some embodiments, the system may be deployed inline or out-of-band at a network perimeter, such as at a firewall, router, or gateway, and may intercept TLS handshake packets using deep packet inspection (DPI) or packet mirroring techniques. For instance, the system may be configured to monitor TCP port 443 traffic and extract the ServerHello message during the TLS handshake to obtain the presented x.509 certificate. In another example, the system may operate as a passive sensor connected to a network tap or span port, capturing TLS handshake metadata and reconstructing certificate chains using tools such as Zeek or Suricata. In yet another example, the system may receive certificate telemetry from distributed agents deployed on endpoints, which may report observed certificates via a secure telemetry channel. The system may also ingest certificate data from external sources, such as certificate transparency logs (e.g., Google's CT log servers), DNS-based Authentication of Named Entities (DANE) records, or third-party threat intelligence feeds. In some implementations, the system may receive certificates via a message broker such as Apache Kafka, AWS Kinesis, or Azure Event Hubs, enabling scalable ingestion pipelines. The network source may include internal enterprise systems, external internet-facing services, or third-party telemetry providers.

At block 304, the system may extract text from the digital certificate. The extracted text may include, but is not limited to, the subject and issuer fields, and may optionally include subfields such as Common Name (CN), Organization (O), Organizational Unit (OU), Country (C), State (ST), Locality (L), and Email address. Additional fields such as serial number, validity period, public key algorithm, key usage extensions, or Subject Alternative Names (SANs) may also be extracted in some embodiments. For example, the system may extract the full subject string “CN=botnet-node-xyz.fakecorp.biz, O-FakeOrg” and the issuer string “CN=UntrustedCA, O=FakeOrg.” In another example, the system may parse and normalize individual subfields such as CN, O, and C into a consistent format using a canonicalization routine. In yet another example, the system may extract SAN entries such as DNS names, IP addresses, or email addresses and include them in the embedding input. In some implementations, missing fields may be imputed with a placeholder string such as “NA” to ensure consistent input formatting. The extracted text may be tokenized, lowercased, stripped of punctuation, or otherwise preprocessed to improve embedding quality. The preprocessing logic may be implemented using regular expressions, ASN.1 parsers, or certificate analysis libraries such as OpenSSL, Bouncy Castle, or Python's cryptography module. In some embodiments, the system may also compute derived features such as the entropy of the subject string, the Levenshtein distance between subject and issuer, or the presence of suspicious keywords (e.g., “test,” “localhost,” “example”) to enrich the embedding input.

At block 306, the system may perform a vector embedding for the extracted text using a pretrained transformer-based encoder to generate a test vector. The embedding process may be performed using one or more of the following techniques. In a first technique, the system may generate a single embedding vector from the subject string alone, which may be suitable for lightweight deployments or scenarios where only the subject field is reliably available. In a second technique, the system may concatenate the subject and issuer strings into a unified input string and generate a single embedding vector from the combined text. This approach may capture relational context between the subject and issuer fields and may be particularly effective when both fields are semantically meaningful. In a third technique, the system may generate separate embedding vectors for the subject and issuer strings and concatenate them to form the test vector. This technique may preserve the distinct semantic contributions of each field and may allow for more flexible downstream analysis. In a fourth technique, the system may generate individual embedding vectors for each of a plurality of parsed features from the subject and issuer fields—such as CN, O, OU, C, ST, L, and email address—and concatenate the resulting vectors to form the test vector. This technique may provide fine-grained control over the representation and may be advantageous in scenarios where certain fields are known to carry more discriminative value. Each of these techniques may be selected based on deployment constraints, model compatibility, or empirical performance on validation datasets.

The encoder used to generate the embedding vector may include, but is not limited to, a character-level or token-level transformer model such as C-BERT, BERT, OpenAI's text-embedding-3-large, AWS Titan, Cohere, or VoyageAI. The resulting test vector may have a dimensionality ranging from approximately 128 to 8192, depending on the embedding technique and model used. For example, the system may embed the subject and issuer strings separately into 768-dimensional vectors and concatenate them into a 1536-dimensional test vector. In another example, the system may embed 14 parsed fields (e.g., 7 from subject, 7 from issuer) into 438-dimensional vectors and concatenate them into a 6,132-dimensional test vector. In yet another example, the system may concatenate the subject and issuer strings into a single input string and generate a unified 1024-dimensional embedding using AWS Titan. In some implementations, the system may apply dimensionality reduction techniques such as Principal Component Analysis (PCA), t-distributed Stochastic Neighbor Embedding (t-SNE), or Uniform Manifold Approximation and Projection (UMAP) to reduce the size of the test vector. The embedding process may be executed on a CPU, GPU, NPU, or other hardware accelerator, and may be optimized for latency, throughput, or memory efficiency. In some embodiments, the system may cache embeddings for frequently observed certificates to reduce redundant computation and improve inference speed.

In one specific implementation, the pretrained transformer-based encoder used to generate the test vector may comprise a character-level model known as C-BERT. C-BERT is a variant of the BERT architecture that replaces the standard token embedding layer with a convolutional neural network (CNN) that operates directly on character sequences. The CNN in C-BERT may include multiple convolutional filters of varying widths (e.g., 1 to 7 characters) to capture local character-level patterns, such as prefixes, suffixes, and subword structures. Each filter may be followed by a non-linear activation function, such as ReLU, and a max-pooling operation to produce a fixed-length representation. The output of the CNN may then be passed to a transformer encoder stack, which may consist of multiple self-attention layers and feedforward sublayers, similar to the original BERT architecture. In some embodiments, the number of convolutional filters, their kernel sizes, and the dimensionality of the resulting embeddings may be configurable. For instance, the system may use 256 filters with kernel sizes ranging from 3 to 5 characters to balance expressiveness and computational efficiency. The maximum input length may be set to 128 or 256 characters to accommodate typical certificate field lengths while maintaining low latency. The final embedding vector produced by C-BERT may have a dimensionality of 768, 1024, or another suitable size depending on the downstream similarity search requirements. This character-level approach may be particularly effective for handling noisy, obfuscated, or syntactically irregular certificate fields, such as those generated by botnet infrastructure or domain generation algorithms (DGAs), where traditional token-based models may struggle to produce meaningful representations.

At block 308, the system may search a vector data structure using the test vector to identify one or more reference vectors. The vector data structure may be implemented using a similarity search engine optimized for approximate nearest neighbor (ANN) retrieval. Suitable engines may include, but are not limited to, FAISS, Milvus, Qdrant, Weaviate, Pinecone, Vespa, Annoy, or ScaNN. The search may be performed using one or more similarity metrics, including cosine similarity, Euclidean distance, dot product, Manhattan distance, Mahalanobis distance, or learned similarity functions such as Siamese networks or contrastive learning models. For instance, the system may use FAISS with a Hierarchical Navigable Small World (HNSW) index to retrieve the top-k nearest neighbors. In another example, the system may use Milvus with IVF-PQ indexing for memory-efficient retrieval. In yet another example, the system may use Qdrant to perform hybrid filtering based on vector similarity and scalar metadata such as certificate issuer, country code, or timestamp. The value of k may range from 1 to 100 or more, depending on the desired trade-off between precision and recall. The vector index may be stored in RAM, GPU memory, or a distributed object store, and may be sharded across multiple nodes for scalability. In some implementations, the system may support namespace-based filtering, time-window filtering, or tag-based filtering to constrain the search space. For example, the system may restrict similarity search to certificates observed within the last 30 days or to those associated with a specific customer environment. In some embodiments, the system may maintain multiple vector indices optimized for different use cases, such as low-latency inference or high-recall forensic analysis.

The reference vector data structure used for similarity search may be constructed by embedding a curated corpus of digital certificates, each labeled as either malicious or non-malicious, into a high-dimensional vector space using the same embedding strategy employed for test certificates. In some embodiments, malicious certificate examples may be collected from publicly available threat intelligence sources such as the SSL Blacklist (SSLBL), Abusc.ch, or VirusTotal, which provide x.509 certificates associated with known botnet command and control (C&C) infrastructure. Additional malicious samples may be obtained through active scanning of suspicious IP address ranges, honeypots configured to intercept TLS handshakes from malware-infected hosts, or sinkholes that capture traffic from defunct botnets. In enterprise environments, malicious certificates may also be identified through retrospective analysis of incident response data, wherein certificates observed during confirmed security events are labeled and archived. Non-malicious certificate examples may be collected from high-reputation sources such as the Alexa Top 1 Million domains, certificate transparency logs from trusted certificate authorities, or internal enterprise systems with known-good TLS configurations. In some implementations, the reference set may be balanced to include an equal number of malicious and benign certificates, or may be weighted to reflect real-world prevalence. Each certificate in the reference set may be preprocessed and embedded using the same transformer-based encoder and vectorization strategy as described with respect to block 306, ensuring consistency between test and reference vectors. The resulting embeddings may be stored in a vector index, such as a FAISS HNSW graph or IVF-PQ structure, along with associated metadata including the original certificate, its label, timestamp, and source. In some embodiments, the reference vector data structure may be periodically updated to incorporate newly observed certificates, remove stale entries, or retrain the embedding model using updated ground truth labels. The system may also support deduplication of reference vectors, clustering of similar certificates, or tagging of vectors with contextual attributes such as malware family, campaign identifier, or geographic origin. This curated and continuously maintained reference set enables the system to perform high-fidelity similarity search and classification of newly observed certificates based on their proximity to known exemplars.

At block 310, the system may classify the digital certificate as malicious or non-malicious based on the reference vector(s). The classification may be determined using one or more of the following techniques: majority voting among the k nearest neighbors; weighted voting based on similarity scores; threshold-based classification using a similarity cutoff; probabilistic inference using softmax-normalized similarity scores; clustering-based classification using precomputed vector clusters; or ensemble methods combining multiple classifiers. For instance, the system may retrieve five nearest neighbors and classify the certificate as malicious if three or more are labeled as malicious. In another example, the system may compute cosine similarity scores and assign weights to each neighbor's vote based on proximity, such that closer vectors exert greater influence on the final classification. In yet another example, the system may apply a softmax function to the similarity scores to produce a probability distribution over class labels and select the label with the highest probability. In some embodiments, the system may use a confidence threshold to suppress low-confidence classifications or defer them to a secondary analysis pipeline for further inspection. The classification logic may be implemented using rule-based heuristics, decision trees, support vector machines, or neural networks, depending on the deployment context and performance requirements. In certain implementations, the system may incorporate additional contextual signals into the classification decision, such as the frequency with which a certificate has been observed, the reputation of the issuing certificate authority, or the presence of known indicators of compromise (IOCs) associated with the certificate's subject or issuer fields. For example, if a certificate is issued by a certificate authority that has previously been associated with malware campaigns, the system may increase the likelihood of a malicious classification. In another example, if the subject field contains a domain name that matches a known domain generation algorithm (DGA) pattern, the system may assign a higher risk score. The classification output may include not only a binary label (e.g., malicious or non-malicious) but also a confidence score, a list of contributing reference vectors, and an explanation of the decision rationale, which may be used for auditing, debugging, or analyst review.

At block 312, the system may perform a network security action based on the classification of the digital certificate as malicious. The action may include, but is not limited to, flagging the certificate for further inspection by security administrators or automated systems; populating a blacklist with the source or destination IP address associated with the certificate; identifying a botnet command and control (C&C) server and generating an alert; updating a threat intelligence feed or SIEM platform; or triggering automated remediation workflows such as firewall rule updates or DNS sinkholing. For example, the system may generate a structured alert containing the certificate fingerprint, classification label, similarity score, and associated IP address, and forward it to a SIEM platform such as Splunk, QRadar, or Elastic Security. In another example, the system may add the IP address of the server presenting the certificate to a dynamic threat intelligence feed or a firewall rule set to block future connections. In yet another example, the system may enqueue the certificate for analyst review in a case management system, tagging it with metadata such as “high-risk C&C infrastructure” or “zero-day botnet candidate.” In some embodiments, the system may log the classification result and associated metadata to a centralized audit log for compliance or forensic purposes. In other embodiments, the system may initiate a feedback loop to retrain the embedding model or refine the vector index based on analyst feedback or newly confirmed labels. For instance, if an analyst confirms that a flagged certificate is indeed malicious, the system may incorporate the corresponding embedding into the reference vector data structure and propagate the updated classification logic to other nodes in a distributed deployment. In some implementations, the system may integrate with orchestration platforms such as SOAR (Security Orchestration, Automation, and Response) systems to automate downstream actions based on the classification outcome. These actions may include isolating affected endpoints, notifying incident response teams, or initiating threat hunting workflows. The system may also support configurable policies that determine which actions to take based on classification confidence, certificate attributes, or organizational risk tolerance.

### Example Embodiments and Experiments

The inventors performed certain experiments using an example system implementing aspects of the foregoing processes, as generally described above. These experiments validate and quantify the improvements and advantages offered not only by the example implementation deployed by the inventors, but also through other implementations according to the systems and methods disclosed herein. Accordingly, the following description is directed to non-limiting examples.

Through analysis of both malicious and benign certificates, the inventors observed that malicious actors tend not to invest significant effort toward obfuscating their certificates (or are unable to convincingly do so), resulting in features that differ notably from those of benign certificates. For example, in addition to lacking credentials that can be verified by trusted certificate authorities, these spoofed or malicious certificates often contain randomly-generated characters, as shown in Table 1 (below), while benign certificates exhibit carefully selected and structured features.

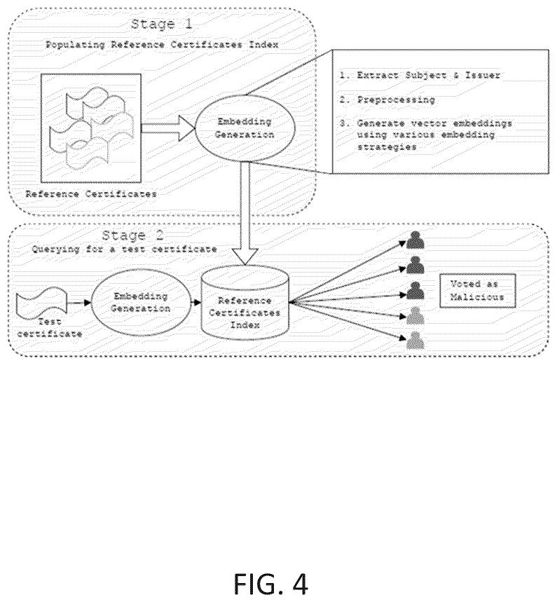

Referring now to FIG. 4, an overview is shown of the example process used by the inventors for classifying digital certificates as malicious or non-malicious in one or more stages. As can be interpreted therefrom, raw TLS certificate string features are first preprocessed to generate a set of information-rich vector embeddings, one per certificate. These vectors are projected to create an embedding space, stored in a vector database, which can later be queried to predict whether or not new certificates are malicious or not.

Thus, as shown, FIG. 4 presents the overall pipeline of the development and deployment of an example system used by the inventors in the experiments described below. Generally-speaking (and subject to various alternatives and refinements contemplated herein), the first step (Stage 1) is an offline or development phase, which involves populating a vector index of embeddings computed from known malicious and benign TLS certificates (called reference certificates in the figure). Once the index is populated, a new test certificate that is not part of the reference certificates can be queried against the embedding space already in the index to be classified as malicious or benign.

In the inventors' experiments, a certain number of malicious and benign certificates were used to generate the vector index. However, it is contemplated that some other implementations may provide further advantages through different approaches to generating the vector index. For example, the vector index may include various tags or metadata so that it can be tailored to fit the characteristics of a future test certificate more closely, such as characteristics of packets or behaviors exhibited by the users of the certificates, IP addresses or other origination information of the certificates, etc. In other embodiments the vector index may be continuously updated to ensure that it contains only embeddings of more “recent” certificates to assist in combatting the evolving techniques and approaches to certificate generation of malicious actors as well as evolving approaches of trusted certificate authorities. In further embodiments, the vector index may be crafted so as to contain a given representative sampling of certificates, such as a given ratio of known malicious and known benign certificates like 50/50, 40/60, 30/70, 25/75, 20/80, 15/85, 10/90, 5/95, 3/97, 2/98, 1/99, etc., and even a threshold number or ratio of certificates from various trusted certificate authorities, known benign self-signing organizations, etc. (such as based upon the types of certificates typically received at a given organizational firewall, etc.). In some embodiments, the composition of the vector index can be dynamically adjusted on a monthly, weekly, or daily basis to reflect the composition of detected certificates.

The same preprocessing steps used to generate the existing embedding space was then used on the test certificates to generate the corresponding embeddings to be used to query against the embedding space in the index to find the k-nearest neighbors. A majority (or other) voting scheme based on the labels of the k-nearest certificates then classifies the new certificate as either malicious or benign. If a majority of the k-nearest neighbors are classified as malicious, the new test certificate is classified as malicious as well, otherwise it is classified as benign.

TABLE 1
Example of a malicious certificate and a benign certificate

| | | | | | Organization | | | |
|---|---|---|---|---|---|---|---|---|
| Malicious | Field | Name | Country | Organization | Unit | Location | State | Email |
| yes | Subject | 192.236.160.249 | mn | xxxyz | zaaaabb | sttuvwww | noopqrrrrs | ccdde@192.236.160.249 |
| yes | Subject | 192.236.160.249 | mn | xxxyz | zaaaabb | stuvwww | noopqrrrrs | 192.236.160.249 |
| no | Subject | www.alg.com.au | AU | AGL Energy | NA | Docklands | Victoria | NA |
| | | | | Limited | | | | |
| no | Issuer | DigiCert, | US | DigiCert Inc | NA | NA | NA | NA |
| | | TLS, RSA, | | | | | | |
| | | SHA2562020CA1 | | | | | | |

The inventors conducted evaluations not only to determine the optimal setup for malicious certificate detection in the general case, but in the most challenging scenarios of 1) handling brand new certificates gathered later than those used to create the embedding space, 2) a zero-day setting to simulate detection performance on emerging C&C groups from organized clusters of threat actors that use specific C&C infrastructure and 3) an evaluation against 150,000 certificates gathered in the wild. Further, not only did the inventors design their experiments to assess the discriminative power of alternative embedding representations, but also to take into account considerations related to the important real-world application of this approach in a production environment, including 3rd party dependencies, open-source, information security, inference time, and cost. With this in mind multiple LLM embedding models were evaluated with different embedding strategies, and the inventors leveraged FAISS, an in-memory vector store, to efficiently to store, search, and retrieve the vectors that make up the embedding space.

### 3.1 TLS Certificate Preprocessing

Each TLS certificate used in the inventors' experiments contained a subject and an issuer, which are data points that can both be useful for botnet detection. A TLS certificate's subject is who it belongs to, such as a domain, and the issuer is the trusted authority that signed it. A subject can take the form www.agl.com.au, O=AGL Energy Limited, L=Docklands, ST-Victoria, C=AU, and an issuer similarly constructed as DigiCert TLS RSA SHA256 2020 CA1, O-DigiCert Inc, C=US. While the whole subject and issuer text strings can be used in full to create vector embeddings, the inventors wished to investigate whether or not separate embeddings for individual attributes are of value. Per Table 1, the preprocessing steps parsed the subject and issuer fields for a given certificate to yield the following:
Name
Country
Organization
Organization unit
Location
State
Email

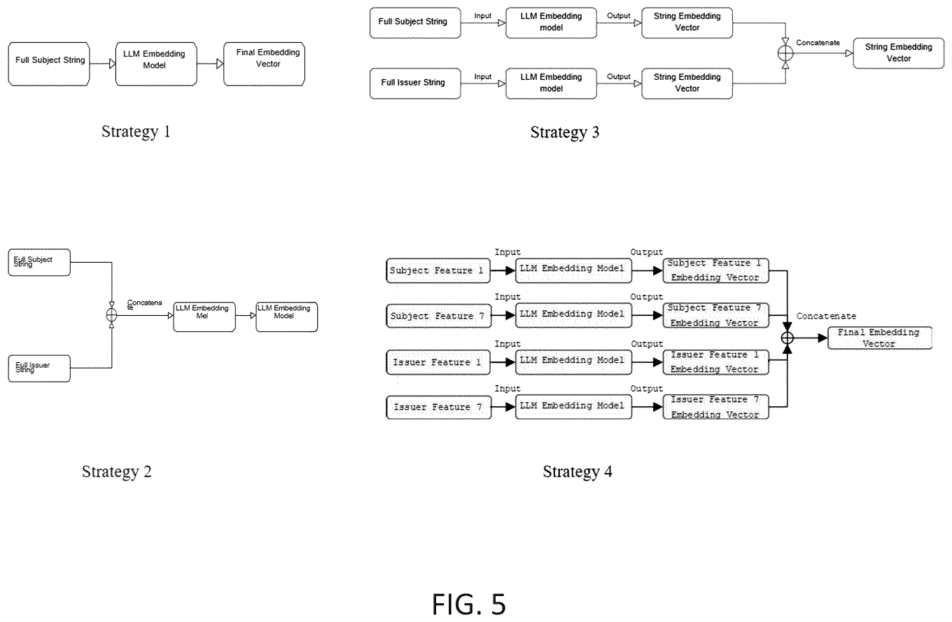

Referring now to FIG. 5, example is illustrated of one or more embeddings made into a final embedding vector. Since SSLBL can often provide only the 7 aforementioned features for malicious TLS certificates, the inventors' study was limited to analyzing these specific fields. Any missing fields within a certificate were imputed with the string NA to ensure consistent data representation during subsequent embedding steps. Once the full text subject and issuer, plus the individual attributes, are extracted as strings, the next step is to embed these strings to create numerical vector representations.

### 3.2 TLS Certificate Embedding Strategies

Vector embeddings have transformed NLP by representing words or documents in high-dimensional spaces, allowing similarity-based tasks such as search. Seminal methods like Word2Vec, GloVe, and FastText were seminal vector embedding methods that have been instrumental for years.

However, pre-trained LLMs can offer new embedding techniques. These pre-trained models can accept entire strings as input and return a fixed-length vector representation, capturing contextual information beyond individual words. As shown in FIG. 5, after first preprocessing each certificate, the text features are then used to generate one or more feature embeddings, which are then concatenated into a final embedding vector. These final embeddings represent the certificates in a high-dimensional space, where similar certificates are in closer proximity and dissimilar certificates further apart. This final embedding creation process involves different embedding strategies to assess their impact on botnet detection performance. The inventors explain them in turn as follows and use n to denote the number of individual embeddings generated from a single certificate in the pre-processing stage.

Embedding Strategy 1: Subject string only-here only the Subject string is used to generate the embedding so n=1. The time taken to generate the embedding can be expressed as: tcert=tembed×n=tembed where tembed is the individual embedding generation time. The length of this final certificate embedding on disk is u=l×n=l, with l being the length of an embedding output from a given model per Table 2.

Embedding Strategy 2: Subject string and Issuer string concatenated—the inventors first concatenate the Subject and Issuer strings to form a unified input string before embedding generation. The inventors have n=1 and the time taken to generate the embedding remains tcert=tembed. The resultant embedding vector remains a length of u=l.

Embedding Strategy 3: Subject string and Issuer string embedded separately—embeddings are generated separately using the Subject and Issuer strings. The resulting two embeddings are then concatenated to create a unified single embedding. Here n=2 and the resulting embedding vector has a dimensionality of u=2l. The time taken for generating this composite embedding is tcert=2tembed.

Embedding Strategy 4: Individual features embedded separately-following the feature extraction procedures outlined in Section 3.1, the inventors generate embeddings for each extracted feature. These embeddings are then concatenated to create a unified single embedding. The total number of features being n=14, the resulting embedding vector has a length of u=14l. As the embedding generation process is repeated for each feature, the total time taken to generate the final embedding vector is tcert=14tembed, assuming no parallel processing.

In the rest of the paper, for brevity the inventors refer to the Embedding Strategy as E, with the integers 1 to 4 representing the four strategies respectively. When running each of these embedding strategies, the choice of LLM affects the size and content of each embedding vector, discussed in the next subsection.

### 3.3 Generative LLM Embedding Model Selection

LLM embedding models convert discrete words or tokens, including characters or phrases, into high-dimensional numerical vectors of floating-point numbers (thus, in a sense, they are encoders rather than generative). These vectors, called embeddings, capture the semantic meaning and relationships between words in a continuous space. For the study, the inventors selected a diverse set of embedding models as shown in Table 2, with a well-established baseline, BERT. This allows for a comprehensive evaluation of the impact of different embedding techniques on the inventors' task. Different embedding models are trained on different text corpora with varying length l of their generated output embedding vectors. More data for training the model may improve performance and longer vectors are more discriminative due their higher dimensionality. A summary of the embedding models used in this work can be found in Table 2.

TABLE 2
Summary of vector embedding models use

| Model | Year | I |
|---|---|---|
| BERT | 2018 | 768 |
| C-BERT | 2020 | 768 |
| Titan | 2023 | 1536 |
| Titan 2 | 2024 | 1024 |
| Cohere | 2023 | 1024 |
| OpenAI | 2024 | 3072 |
| VoyageAI | 2024 | 1024 |

BERT serves as the inventors' baseline model due to its widespread adoption and open-source nature. This choice facilitates the reproducibility of the inventors' research and allows comparison with other embedding models.

C-BERT: The inventors specifically incorporate C-BERT due to its character-level processing. This approach is particularly advantageous for capturing semantic relationships within single words, which may be effective for the inventors' task as subjects and issuers are often short and potentially ambiguous entities.

OpenAI text-embedding-3-large: OpenAI's text-embedding-3-large model is used extensively within the research community.

AWS titan-embed-text: v1:0: Amazon's Titan embedding models are widely used within the AWS ecosystem. Titan v1.0 serves as the default embedding model.

AWS titan-embed-text: v2:0: Amazon's Titan 2, released in May 2024, with the intent of giving improved performance compared to its predecessor.

Cohere embed-english-v3.0: Cohere's embed-english-v3.0 model is another regular choice within the research community. Its inclusion allows for a broader comparison across various embedding models.

Voyage AI Voyage-large-2-instruct: At the time of conducting this work, voyage-large-2-instruct held the top position on the MTEB leaderboard. This performance record motivated its inclusion within the inventors' model selection.

Generated vectors are stored in an in-memory FAISS vector database. Vector databases are designed for highly efficient retrieval and comparison of vectors. Using a vector database to store and query certificates based on their embedded representations is advantageous to using other methods such as iterating over lengthy CSV files. To create the FAISS index, the generated certificate embeddings are fed into the FAISS library, with FAISS data structures facilitating efficient nearest neighbor search within the embedding space.

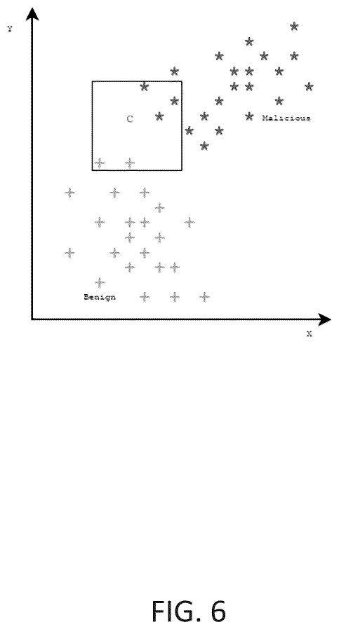

FIG. 6 illustrates an example of a test certificate being queries against one or more known malicious and non-malicious certificates projected in a 2D embedding space.

### 3.4 Classifying an Unseen TLS Certificate Using kNN and FAISS

The inventors' approach leverages vector similarity search for classifying a previously unseen TLS certificate as malicious or benign. The inventors considered three similarity metrics: cosine similarity, Euclidean distance, and dot product. Let A=(A1, . . . , An) and B=(B1, . . . , Bn) be two vectors between which the metrics are being calculated.

$$cosine\_similarity = \frac{A \cdot B}{\vert A \vert \vert B \vert}$$

Cosine similarity excels at capturing directional alignment, making it suitable for tasks where relative orientation matters more than absolute magnitude. However, it can be insensitive to magnitude differences.

$$euclidean\_distance = \sqrt{{\sum }_{i = 1}^{N} {( {A}_{i} - {B}_{i} )}^{2}}$$

Euclidean distance provides a direct measure of distance in the vector space but can be swayed by varying vector lengths.

$$dot\_product = A \cdot B$$

Dot product, while computationally efficient, inherits limitations from both cosine similarity and Euclidean distance—sensitive to both direction and magnitude without normalization.

The inventors also conducted an ablation study between these three metrics in order to choose the one that appears most performant for their task.

The inventors' choice of FAISS for vector indexing and retrieval stems from its suite of optimized indexing algorithms. FAISS implements a variety of indexing techniques that significantly accelerates search times compared to brute-force approaches. This efficiency is attractive for the inventors' work dealing with datasets at several orders of magnitude in size. FAISS also demonstrates excellent scalability, allowing for efficient operations on collections that grow in size over time. This characteristic ensures the inventors' solution remains performant as their dataset expands, and likely would be of benefit in a production setting. Given a test certificate, its embedding is generated using the same embedding model employed for the reference certificates. This test certificate embedding is then used to query the pre-built FAISS index.

FAISS retrieves the k closest neighbors, that is, the k certificate embeddings most similar to the test certificate embedding from the index. The value of k represents a parameter that controls how many nearest neighbors are selected and returned. A larger k value encompasses a broader neighborhood for comparison, potentially improving robustness, but may also increase computational cost. Finally, a classification decision is made based on the majority vote from the retrieved nearest neighbors.

FIG. 6 illustrates a test certificate C being queried against known malicious and benign certificates projected in a 2D embedding space, with the bounding box representing the voting process. In practice though, per Table 2, each embedding is several order of magnitudes larger than 2 (or 3 if one opts to use 3D rendering), so visualization is not possible. But the underlying vector similarity principles are the same. If more than half, i.e., k/2, of the k nearest neighbors belong to the malicious class, the test certificate is classified as malicious. Otherwise, it is classified as benign. Formally:

$$Malicious ( C ) ⇔ \vert ⋂ ℳ \vert > \frac{\vert \vert}{2}$$

where Malicious (C) represents a function that outputs True if the test certificate C is deemed malicious and False otherwise. [symbol] represents the set of the k-nearest neighbors of certificate C in the vector space, with [symbol] representing all the malicious certificates in the dataset and the intersection of both is the number of malicious certificates returned.

### 4 Experimental Setup

The inventors conducted their experiments in multiple progressive stages, with the early experiments being ablation studies. To begin with each of the embedding strategies are assessed to ascertain the most performant, followed by selecting the ideal distance metric. With these two aspects of the configuration fixed, the inventors then vary the embedding model itself, per the previous selected list in Section 3.3. In this way the inventors can see the performance of the open source compared to closed source embedding models using the same selected optimal embedding strategy and distance metric. After this the inventors chose the best performing open-source model, and the best performing closed source model to evaluate against each other on held-out test data. The impact of varying k in the voting system is investigated plus importantly in the final stages the inventors conduct three important experiments. The first ascertains the performance of the system with new certificate data gathered after that used to conduct the earlier ablation studies. The second subjects the system to a challenging zero-day scenario of detecting TLS certs from emerging C&C groups by removing them from the dataset when creating the initial embedding space and then only using those same removed C&C certs for testing. Thirdly the inventors evaluate their approach on TLS certificates crawled from the internet to examine its utility in real-world operations.

### 4.1 Datasets

A collection of malicious botnet certificates was obtained from the SSL Blacklist (SSLBL), a publicly available benchmark frequently used in previous published works. SSLBL is a project designed to identify and blacklist TLS certificates associated with botnet command and control (C&C) servers, thereby enabling research into the detection of malicious connections. The inventors curate two datasets from SSLBL at different points in time to give more confidence in their evaluations. The first dataset contains 2,516 certificates gathered between 2014 May 4 and 2024 Jan. 11, and the second dataset contains a further 149 certificates gathered between 2024 Jan. 11 and 2024 Jun. 3. Both datasets also include the C&C group attributed to each certificate. The inventors balance the first dataset by adding 3,000 benign certificates randomly selected from the Alexa Top 1 Million list, a publicly available ranking of the most visited websites. The inventors assume these websites are not malicious. Similarly, the inventors balance the second dataset with 150 randomly selected certificates from the Alexa Top 1 Million list. There is no overlap in the certificates between Dataset One and Dataset Two.

Dataset One is used in ablation studies to select the optimal configuration for embedding strategy, distance metric, and embedding model. The inventors then perform an evaluation in Section 5.5 holding this optimal configuration constant and testing it using Dataset Two as held-out and unseen test data, where the botnet certificates were collected later than those in Dataset One. The botnet certificates' statistics in the two datasets are summarized in Table 3 and 4. To be concise, only the 10 largest attributed C&C groups are listed.

TABLE 3
Top 10 C&C group certs in Dataset One (malicious certs collected
between 2014 May 4 and 2024 Jan. 11 from SSLBL)

| Attribution | # Count |
|---|---|
| AsyncRAT | 495 |
| Dridex | 358 |
| Gozi | 174 |
| Quakbot | 145 |
| Malware | 142 |
| BitRAT | 141 |
| TorrentLocker | 135 |
| KINS | 120 |
| Gootkit | 116 |
| QuaserRAT | 98 |

TABLE 4
Top 10 C&C group certs in Dataset Two (malicious certs collected
between 2024 Jan. 11 and 2024 Jun. 3 from SSLBL)

| Attribution | # Count |
|---|---|
| AsyncRAT | 58 |
| QuasarRAT | 43 |
| PureLogStealer | 24 |
| OrcusRAT | 7 |
| DCRat | 4 |
| Latrodectus | 4 |
| VenomRAT | 3 |
| AgentTesla | 2 |
| Rhadamanthys | 2 |
| RedLineStealer | 1 |
| Malware | 1 |
| Njrat | 1 |

### 4.2 Data Partitioning and Cross-Validation

The first dataset gathered between 2014 May 4 and 2024 Jan. 11 is divided into training, validation, and testing sets. Note in broader AI/ML model sense, the training step is synonymous with us creating the embedding space against which to evaluate other certificates, rather than training a neural network model itself; for brevity the inventors still refer to the portion of data used to create the embedding space as the training data. Firstly, a stratified 10% holdout was created for the testing set, ensuring the test data distribution reflects the overall dataset. The test dataset remains untouched for subsequent performance comparisons of various models as detailed in Section 5.4. The remaining 90% of the data is used in the ablation studies where, to mitigate overfitting and give more confidence in generalization potential of the inventors' approach, stratified 5-fold cross-validation is performed. Each fold comprises 80% of the dataset for training and 10% for validation, and the reported results in the ablation experiments in Section 5.1, 5.2 and 5.3 are the average across the five validation splits. To further evaluate the system's ability to predict future malicious certificates, Dataset 2 with botnet certificates gathered between Jan. 12, 2024 and Jun. 3, 2024, is used entirely as test data.

For evaluation results to more accurately reflect the machine learning model's utility in practice, testing data shall be from later times than training data. Dataset 2 is for that purpose; the evaluation results on it (Section 5.5) are intended to examine the inventors' approach's effectiveness when the train/test partition follows realistic temporal orders

### 4.3 Evaluation Metrics

The inventors frame TLS certificate detection as a supervised binary classification problem. Each certificate is labelled as either malicious, which is the positive class, or benign, which is the negative class. A correct identification of a malicious certificate results in a True Positive (TP), while a correct identification of a benign certificate resulted in a True Negative (TN). A False Positive (FP) occurs when a benign certificate is mistakenly predicted as malicious, and a False Negative occurs when a malicious certificate is missed and incorrectly predicted as benign. Hence a focus can be on minimizing the false positive rate (FPR) while concurrently monitoring the miss rate (MR), also known as false negative rate. Achieving a complete absence of FPs is impractical in real-world applications. To evaluate performance, the metrics accuracy, precision, recall, F1-score, FPR, and MR are formally defined as follows:

$$accuracy = \frac{TP + TN}{TP + TN + FP + FN} \qquad ( 5 )$$

$$precision = \frac{TP}{TP + FP} \qquad ( 6 )$$

$$recall = \frac{TP}{TP + FN} \qquad ( 7 )$$

$${F}_{1} = \frac{2 \times precision \times recall}{precision + recall} \qquad ( 8 )$$

$$false positive rate = \frac{FP}{FP + TN} \qquad ( 9 )$$

$$miss rate = \frac{FN}{TP + FN} = 1 - recall \qquad ( 10 )$$

Since miss rate can be derived from recall the inventors do not separately report it in the experiment results.

### 5 Results

### 5.1 Embedding Strategy Ablation Study

A first experiment aims to identify the most effective embedding strategy from the four options explained previously in Section 3. The inventors hold the embedding model constant as OpenAI, k=5 and the distance metric as cosine. Then the inventors vary each embedding strategy E from 1 to 4, creating the vector embedding space from the training split of the first dataset, and evaluating with the validation split. This allows the experimental setup to monitor any performance changes that occur as a direct result of changing the embedding strategy. Results in Table 5 show employing only the subject as an encoded feature, where E=1, yields significantly lower performance compared to other strategies. Considering the F1 score, E=3 emerges as the clear winner, achieving an accuracy of 0.994, precision of 0.989, recall of 0.998, and F1 score of 0.994. Thus, as embedding the subject and issuer strings separately preserves the signal in both. For E=4, where every attribute of the subject and issuer are first embedded and then concatenated, performance is very good, however when compared to E=3, E=4 uses all possible n=14 features, and hence creates fourteen feature vectors, seven from the subject and seven from the issuer that are then concatenated. Per previous in Section 3.2, this requires 7× the generation time and 7× disk space of 14tembed and 14l respectively, compared to the concatenation of only two feature vectors with 2tembed and 2l for E=3. This further confirms E=3 as an effective setting in the inventors' example implementation, where the full subject and issuer strings are embedded separately and then concatenated. Thus E=3 is fixed for the remainder of the experiments.

TABLE 5
Performance across the four embedding strategies

| E | Accuracy | Precision | Recall | F1 | FP % |
|---|---|---|---|---|---|
| 1 | 0.852 | 0.817 | 0.869 | 0.842 | 16.267 |
| 2 | 0.965 | 0.986 | 0.936 | 0.960 | 1.133 |
| 3 | 0.994 | 0.989 | 0.998 | 0.994 | 0.933 |
| 4 | 0.989 | 0.984 | 0.992 | 0.988 | 1.333 |

### 5.2 Distance Metric Ablation Study

Building upon the previous experiment where E=3 emerged as the best choice, the inventors next focusex on identifying the optimal similarity metric for the classification task. Per previous Section 3, cosine, dot product and Euclidean are under scrutiny. The inventors held the embedding model constant as OpenAI, k=5 and E=3 whilst varying the distance metric. The inventors also reported the inference time t, measured in milliseconds, to predict a single certificate. Results in Table 6 show the cosine metric achieves the highest F1 score of 0.994 with a marginally longer inference time than dot product and Euclidean. While a trade-off exists between inference speed and detection performance, the significant improvement in F1 score justifies fixing the use of cosine in the remaining experiments.

### 5.3 Embedding Model Ablation Study

TABLE 6
Performance across the three-distance metrics

| Distance Metric | t (ms) | Acc | Prec | Recall | F1 | FP % |
|---|---|---|---|---|---|---|
| Cosine | 0.177 | 0.994 | 0.989 | 0.998 | 0.994 | 0.933 |
| Dot Product | 0.124 | 0.960 | 0.952 | 0.961 | 0.956 | 4.067 |
| Euclidean | 0.114 | 0.977 | 0.988 | 0.961 | 0.974 | 1.000 |

TABLE 7
Performance across the seven embedding models

| Model | t (ms) | Acc | Prec | Recall | F1 | FP % | OSS |
|---|---|---|---|---|---|---|---|
| OpenAI | 0.177 | 0.994 | 0.989 | 0.998 | 0.994 | 0.933 | no |
| Titan | 0.078 | 0.990 | 0.986 | 0.993 | 0.989 | 1.200 | no |
| Cohere | 0.037 | 0.987 | 0.985 | 0.987 | 0.986 | 1.333 | no |
| Titan2 | 0.046 | 0.987 | 0.984 | 0.987 | 0.986 | 1.333 | no |
| Voyage | 0.068 | 0.960 | 0.985 | 0.926 | 0.954 | 1.200 | no |
| BERT | 0.029 | 0.958 | 0.968 | 0.939 | 0.953 | 1.600 | yes |
| C-BERT | 0.064 | 0.983 | 0.992 | 0.970 | 0.981 | 0.667 | yes |

In the previous two experiments the embedding model was held constant as OpenAI. Having selected which E and distance metric to use, here the inventors investigate how performance varies across the inventors' chosen set of embedding models which are a mix of open and closed source. For some tasks open-source models may generate embedding vectors which could be as discriminative as those from 3rd party closed-source offerings, without many of the dependencies, costs, and security considerations that vendor-based solutions introduce. Hence, the inventors conducted experiments to see if this is the case in their example implementation for detecting botnet certificates. Holding E=3, the distance metric as cosine, and k=5, the inventors vary the choice of embedding model across OpenAI, Titan, Titan2, Cohere, C-BERT, BERT and VoyageAI.

Results in Table 7 (OSS column indicates open source or not) show C-BERT emerges as a strong open-source contender, achieving a competitive F1 score of 0.981 that is comparable to OpenAI which had an F1 score of 0.994. However notably, C-BERT's inference time t in predicting a certificate is 0.064 ms, which is almost 64% faster than OpenAI's 0.177 ms. It can also be said that, unlike OpenAI, Titan, Titan 2, Cohere, and Voyage, C-BERT is open-source, reducing external dependencies, cost, and potential security risks associated with third-party API egress. Having identified this suitable open-source alternative, C-BERT, with comparable performance to OpenAI, the inventors proceed to the evaluation phase. The next step involves a head-to-head comparison of C-BERT and OpenAI using the held-out test data.

### 5.4 Held-Out Unseen Test Data Evaluation

As a reminder, per Section 4.2, at the outset 10% percent of the first dataset was reserved for this unseen test data evaluation. Taking both the OpenAI and C-BERT models, with E=3, distance metric cosine and k=5, the inventors test both models with this held out 10%. Results in Table 8 demonstrate C-BERT exhibits strong competitive performance, slightly surpassing OpenAI with an F1 score of 0.994 compared to 0.990. C-BERT additionally achieves a FP rate of 0.397% which is less than half that of OpenAI's and a miss rate of 0.667% that is lower than OpenAI's 1%. Further, it can be seen C-BERT achieves this performance level with a significantly faster inference time t of 0.021 ms compared to OpenAI's 0.088 ms. Two factors can contribute to the observed running time difference. Firstly, C-BERT operates entirely on local hardware, while the OpenAI embedding model relies on an API for access, introducing potential network latency. Secondly, the final vector length of the C-BERT embedding output, 1,536, is smaller than that of the OpenAI model, 6,144, giving C-BERT a more favorable t. It is also likely that C-BERT's design for character-level operations contributes to its competitiveness in the inventors' use case that involves relatively short strings.

TABLE 8
Performance on held-out test data

| Model | t (ms) | Acc | Prec | Recall | F1 | FP % |
|---|---|---|---|---|---|---|
| OpenAI | 0.088 | 0.991 | 0.988 | 0.992 | 0.990 | 1.000 |
| C-BERT | 0.021 | 0.995 | 0.992 | 0.996 | 0.994 | 0.667 |

### 5.5 Simulated Future TLS Certificate Detection Evaluation

The previous experiments have demonstrated the classification capability of the inventors' approach with strong performance in Section 5.4 using the held-out 10% test split of the first dataset. Recall this first dataset included malicious certificates identified on SSLBL up to and including Jan. 11, 2024. A sterner test is to evaluate model performance on what the inventors describe as unseen data that is collected later in time, accounted for in their methodology by curating a second dataset of certificates newly posted on SSLBL between Jan. 12, 2024, and Jun. 3, 2024, comprising 149 certificates. If the inventors had deployed the system in January 2024 with a vector embedding space using data up until that point in time, the objective now is to measure the simulated production performance between January 2024 and June 2024 on these 149 malicious certificates. With E=3, k=5 and distance metric cosine held constant, both C-BERT and OpenAI were again evaluated with this new data. The C-BERT model achieved an F1 score of 0.979, compared to OpenAI's 0.960. This further shows the advantage of the open-source C-BERT model in a production setting, compared to OpenAI vendor solution.

TABLE 9
Performance on future TLS certificates

| Model | t (ms) | Acc | Prec | Recall | F1 | FP % |
|---|---|---|---|---|---|---|
| OpenAI | 0.032 | 0.959 | 0.966 | 0.953 | 0.960 | 3.401 |
| C-BERT | 0.023 | 0.979 | 0.973 | 0.986 | 0.979 | 2.649 |

### 5.6 Simulated Zero-Day C&C Group Evaluation

With C&C groups emerging over time, a botnet certificate detection system should ideally still be able to identify malicious certs belonging to emerging, brand-new C&C groups, akin to zero-day detection in a malware scenario. The SSLBL public benchmark dataset used in this work is curated in such a manner that each certificate comes with the responsible attributed C&C group. In this way, it becomes possible to remove a given C&C group from the setup of the vector embedding space and then test using that same removed C&C group. To evaluate the performance of C-BERT model embeddings in this manner, the inventors hold E=3, k=5 with the cosine distance metric per previous, while conducting a targeted experiment holding out four C&C groups for testing—Vawtrak MITM, Corebot C&C, VenomRAT C&C, and VMZeuS C&C. These C&C groups are entirely withheld from the setup of the vector embedding space, which utilizes all the other remaining certificates.

TABLE 10
Simulated zero-day C&C group evaluation

| C&C | # | t | | | | | FP* |
|---|---|---|---|---|---|---|---|
| Family | Certs | (ms) | Acc | Prec | Recall | F1 | % |
| Vawtrak | 13 | 0.034 | 0.900 | 0.867 | 0.929 | 0.897 | 12.500 |
| Corebot | 10 | 0.042 | 1.000 | 1.000 | 1.000 | 1.000 | 0.000 |
| VenomRAT | 9 | 0.021 | 0.950 | 0.900 | 1.000 | 0.947 | 9.091 |
| VMZeuS | 9 | 0.033 | 0.900 | 0.900 | 0.900 | 0.900 | 10.000 |
| Average | 10.25 | 0.032 | 0.937 | 0.917 | 0.957 | 0.936 | 7.898 |

TABLE 11
Comparison of k = 5 and k = 1

| | | t | | | | | FP |
|---|---|---|---|---|---|---|---|
| Model | k | (ms) | Acc | Prec | Recall | F1 | % |
| Average | 10.25 | 0.032 | 0.937 | 0.917 | 0.957 | 0.936 | 7.898 |
| C-BERT | 1 | 0.022 | 0.996 | 0.996 | 0.996 | 0.996 | 0.333 |
| C-BERT | 5 | 0.021 | 0.995 | 0.992 | 0.996 | 0.994 | 0.667 |
| OpenAI | 1 | 0.093 | 0.995 | 0.992 | 0.996 | 0.994 | 0.667 |
| OpenAI | 5 | 0.088 | 0.991 | 0.988 | 0.992 | 0.990 | 1.000 |

This results in four new, balanced zero-day test datasets containing each of the new C&C group certificates along with the same number of benign certificates. In total the four testing sets contain 41 botnet certificates and 41 benign certificates.

Results in Table 10 show excellent detection performance with an average F1 score of 0.936 across the four withheld families, a promising result given the challenging nature of the experiment to try to correctly identify certificates from C&C groups not present in the original vector embedding space. This shows the inventors' approach using C-BERT effectively generalizes to unseen C&C families in the wild as they emerge. Due to the limited sample size, the measured performance metrics are much more coarse-grained than in the other experiments. For example, for a test set with 10 benign certificates, a single false positive result will yield a 10% false positive rate. This explains why the false positive rates are much higher compared to the other data sets.

5.7 Comparison Between k=5 and k=1

The voting mechanism in the inventors' experiments uses k=5, with the certificate prediction of malicious or benign depending on the majority label of the five nearest neighbors. For this experiment, the inventors determine any change in performance for a more difficult setup where the similarity search and retrieval can only operate with k=1, in that the prediction will match the label of the closest certificate in the existing embedding space compared to the projected location of a new certificate. To do so, the inventors evaluated the performance of C-BERT and OpenAI with k=1, again forcing the similarity search to select the single closest embedding in the high dimensional embedding space. Results in Table 11 show C-BERT achieves competitive performance with an F1 score of 0.996, even when k=1, compared to OpenAI's 0.994.

It is specifically contemplated, however, that k could be a variety of other numbers, and even other methods for similarity assessment are usable in other implementations. For example, in some embodiments, k may be 10, 15, 20, or a higher number; a k nearest-neighbors algorithm may be modified to dynamically provide only those examples that are sufficiently similar; additional similarity measurements may also be calculated (such as cosine similarity, Euclidean distance, approximate nearest neighbor (ANN), Siamese or triplet networks, etc) as an ensemble and a second order voting mechanism used to determine a consensus among them (e.g., normalized relative similarity scores could weight the result of each similarity scheme).

The comparison in Table 11 indicates that while using k=5 provides a robust voting mechanism, the setup with k=1, which relies on the single closest embedding, still yields impressive results with a competitive F1 score of 0.996 for C-BERT and 0.994 for OpenAI.

### 5.8 In the Wild-Real World Data Evaluation

Curated datasets used for evaluating machine learning approaches for cyber security are inevitably biased. This is due to the fact that ground truths are hard to obtain for data related to security tasks. To create datasets with ground truths, one often has to compromise on data distribution being representative of the real world. Manually examining a TLS certificate and the IP address where it was retrieved to determine its maliciousness is doable for a few cases but is infeasible for creating a dataset large enough for machine learning research. Thus, using sites' popularity as a proxy for being benign and using published blacklisted certificates as a proxy for being malicious, is a reasonable compromise in creating a dataset. The decision to use a mix of the SSLBL public benchmark certs and those from the Alexa Top 1 Million list is based on this consideration. However, one shall bear in mind that this mix does not represent the distribution of malicious and benign certificates in the wild. This is a dilemma researchers applying AI/ML to cybersecurity always have to deal with.

The inventors examined the utility of a security tool through the lens of effort saving. In this evaluation, the inventors used the following as a goal of a sample security task: “find at least one malicious TLS certificate in the wild.”

To collect real world SSL/TLS certificate on the internet, the inventors leveraged the extensive dataset provided by Rapid7's Project SONAR. Project SONAR conducts comprehensive internet-wide scans, meticulously collecting data on SSL/TLS certificates from a vast array of websites and services. For the research, the inventors selected a random sample of 150,000 unique SSL/TLS certificates from the trove of scans conducted between Jan. 2, 2024, and May 26, 2024. The inventors then applied their classifier on these 150,000 certificates, which reported 13 of them as botnet certificates. While it is infeasible to check the ground truth of all the 150,000 certificates, it is totally feasible to check the ground truth of 13. Using VirusTotal (VT), a public service for checking the maliciousness of files, URLs, or IPs, the inventors checked the 13 IP addresses where the 13 botnet certificates were obtained. One of them was confirmed as malicious. This means that by using the classifier, the inventors did indeed find one malicious TLS certificate from 150,000, by examining only 13. The precision of the inventors' tool on the 150,000 certificates is 1/13=7.7%, significantly lower than the upper 90 percentage points from the earlier experiments. There are a number of reasons for this: the curated dataset is balanced, with equal number of benign and malicious certificates. In the real-world botnet certificates likely constitute a minuscule portion of the TLS certificates in the wild. Due to the base-rate fallacy, even if a detector has extremely high detection accuracy, when the prevalence of the target event is low, the precision will be substantially reduced. The other reason is that real-world data does not have the composition bias explained above. The bias could result in artifacts that make the classification task easier. This further demonstrates the importance of evaluating an ML-based security tool on real-world data, in addition to curated datasets.

Though an application like VT can provide the ground truth, it is not feasible to run all the 150,000 IP addresses through it and thus label all the TLS certificates in this real-world dataset. In fact, the ground truths from VT are not free. Each is the result of running a sample through a number of AV products, based on the vendors' threat intelligence that ultimately involves substantial human labor. For this reason, VirusTotal is not a free service. One can only query up to 500 samples each day without cost; beyond that an expensive subscription is required. Scanning all 150,000 would be cost prohibitive, either in monetary term or time, and would not be able to keep up with the pace or latency requirements of certificate scanning at an organizational entry point. Scanning a sample through VT can thus be further seen as a proxy for human toll needed to determine if a TLS certificate is malicious.

To demonstrate an improvement in detection rate and required resource commitment, the inventors also gave this process 100 times human efforts as in the previous case. Using VirusTotal as a proxy for such human efforts, the inventors allowed querying VT 1,300 times (vs. 13 times when the inventors' classifier was used). The inventors thus randomly selected 1,300 certificates from the 150,000, and ran them through VT. Out of the 1,300, none were confirmed as malicious by VT.

Thus, it can be seen that using the classifier, the inventors only needed to query VT 13 times to identify one confirmed malicious certificate. Not using the classifier, after querying VT 1,300 times no confirmed malicious certificate had been found. Thus, for the objective of identifying at least one malicious TLS certificate in the wild, the inventors' classifier provided at least a 100× human effort reduction for these 150,000 TLS certificates crawled from the internet.

The extent to which LLMs and similarly-sized networks can be utilized as part of a solution in a given cybersecurity use case is often dependent on factors like: governance and information security risk, engineering dependencies, plus availability of compute resources and energy domains. Data privacy, egress beyond trusted boundaries, coding against 3rd party APIs vulnerable to change, and potential performance impacts from even minor 3rd party model updates may also be considered.

For botnet certificate detection, the inventors' experiments demonstrate that desirable traits also include the ability for a model to be self-hosted with internally documented and managed APIs, requiring no egress beyond a trusted boundary. Further, by controlling a model (e.g., frozen or managed updating), there should be no unexpected changes to the actual model binary due to the checks and balances associated with engineering hygiene in the enterprise. By eliminating reliance on third-party APIs and self-hosting open-source solutions for generating vector embeddings, the attack surface reduces to help mitigate the risk of LLM vulnerabilities such as model poisoning.

Systems and software, e.g., implemented on a non-transitory computer-readable medium, for performing the methods discussed herein are also within the scope of embodiments of the present disclosure.

Embodiments of the present disclosure may thus utilize a special purpose or general-purpose computing system including computer hardware, such as, for example, one or more processors and system memory. Embodiments within the scope of the present disclosure also include physical and other computer-readable media for carrying or storing computer-executable instructions and/or data structures, including applications, tables, data, libraries, or other modules used to execute particular functions or direct selection or execution of other modules. Such computer-readable media can be any available media that can be accessed by a general purpose or special purpose computer system.

Computer-readable media that store computer-executable instructions (or software instructions) are designed to temporarily or permanently hold software instructions. Examples include memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other medium which can be used to store program code in the form of computer-executable instructions or data structures and which can be accessed by a general purpose or special purpose computer, whether such program code is stored as or in software, hardware, firmware, or combinations thereof.

A “network” or “communications network” may generally be defined as one or more data links that enable the transport of electronic data between computer systems and/or modules, engines, and/or other electronic devices. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instructions or data structures and which can be accessed by a general purpose or special purpose computer.

The term “execution by a computer” as used herein refers to the performance of operations, tasks, or functions by a computing device or system, including but not limited to, in various execution environments such as bare metal, virtual machines, containers, and any other computing environments. Execution by a computer includes a computer making a remote function call to another computer, where the first computer initiates and executes the function. This definition encompasses scenarios where operations are executed using one or more types of accelerators, such as digital signal processors (DSPs), neuromorphic chips, application-specific integrated circuits (ASICs), or other specialized processing units. In such instances, the processor of the computer may delegate specific tasks to these accelerators to enhance performance, efficiency, or capability.

Furthermore, the term “execution by a computer” includes the execution of software, instructions, or algorithms stored on computer-readable media. It covers any combination of hardware, firmware, and software components required to perform the desired operations. This definition should be interpreted broadly to include any system where a computer or computing device carries out the execution of tasks, whether the tasks are performed locally, remotely, or distributed across multiple computing environments and devices.

The term “computer” as used herein refers to any general-purpose or special-purpose computing device capable of processing instructions and performing operations, including, but not limited to microprocessors, microcontrollers, DSPs, neuromorphic chips, ASICs, programmable gate arrays, or any combination thereof. The computer may operate standalone or as part of a network or a larger system, and may communicate with other electronic devices and systems through various communication interfaces and protocols.

The definitions provided herein are intended to encompass the broadest possible scope of execution by a computer, reflecting the diverse and evolving nature of computing technologies and environments. All variations, modifications, and equivalents that fall within the spirit and scope of the claims are intended to be embraced by the claims.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

As used in this specification and the claims, the singular forms “a,” “an,” and “the” include plural forms unless the context clearly dictates otherwise. The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims. Any trademarks mentioned herein are the property of their respective owners.

As used herein, the term “random” represents an outcome or value that is produced without a clear pattern or predictability. For example, the term “random” may refer to values that are generated by an algorithm or process designed to produce results that mimic true randomness, such as pseudorandom values. Further, it should be understood that any uses of the term “random” in the preceding description are intended to include both truly random and pseudorandom values. If there are uses of the term that are not clear to persons of ordinary skill in the art given the context in which it is used, “random” will mean values or outcomes that appear to be without pattern or predictability, regardless of the method of generation.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean up to plus or minus 10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion of additional components other than the components recited in the claims. The term “consisting essentially of” should be interpreted to be partially closed and allowing the inclusion only of additional components that do not underlyingly alter the nature of the claimed subject matter. Any trademarks are the property of their respective owners.

The phrase “such as” should be interpreted as “for example, including.” Moreover, the use of any and all example language, including but not limited to “such as”, is intended merely to better illuminate the invention and does not pose a limitation on the scope of the invention unless otherwise claimed.

Furthermore, in those instances where a convention analogous to “at least one of A, B and C, etc.” is used, in general such a construction is intended in the sense of one having ordinary skill in the art would understand the convention (e.g., “a system having at least one of A, B and C” would include but not be limited to systems that have A alone, B alone, C alone, A and B together, A and C together, B and C together, and/or A, B, and C together.). It will be further understood by those within the art that virtually any disjunctive word and/or phrase presenting two or more alternative terms, whether in the description or figures, should be understood to contemplate the possibilities of including one of the terms, either of the terms, or both terms. For example, the phrase “A or B” will be understood to include the possibilities of “A” or “B” or “A and B.”

All language such as “up to,” “at least,” “greater than,” “less than,” and the like, include the number recited and refer to ranges which can subsequently be broken down into ranges and subranges. A range includes each individual member. Thus, for example, a group having 1-3 members refers to groups having 1, 2, or 3 members. Similarly, a group having 6 members refers to groups having 1, 2, 3, 4, or 6 members, and so forth.

The modal verb “may” refers to the preferred use or selection of one or more options or choices among the several described embodiments or features contained within the same. Where no options or choices are disclosed regarding a particular embodiment or feature contained in the same, the modal verb “may” refers to an affirmative act regarding how to make or use an aspect of a described embodiment or feature contained in the same, or a definitive decision to use a specific skill regarding a described embodiment or feature contained in the same. In this latter context, the modal verb “may” has the same meaning and connotation as the auxiliary verb “can.”

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. A method of evaluating a digital certificate, comprising:
receiving the digital certificate from a network source;
extracting text from the digital certificate;
performing a vector embedding for the extracted text using a pretrained transformer-based encoder to generate a test vector;
searching a vector data structure using the test vector to identify a reference vector; and
classifying the digital certificate as malicious or non-malicious based on the reference vector.

2. The method of claim 1, further comprising:
identifying a botnet command and control server associated with the digital certificate in response to classifying the digital certificate as malicious.

3. The method of claim 1, further comprising:
populating a blacklist with a source or destination network address associated with the digital certificate in response to classifying the digital certificate as malicious.

4. The method of claim 1, wherein performing the vector embedding comprises generating a single embedding vector from a subject string of the digital certificate.

5. The method of claim 1, wherein performing the vector embedding comprises:
concatenating a subject string and an issuer string of the digital certificate into an input string; and
generating an embedding vector from the input string.

6. The method of claim 1, wherein performing the vector embedding comprises:
generating separate embedding vectors for a subject string and an issuer string of the digital certificate; and
concatenating the separate embedding vectors to form the test vector.

7. The method of claim 1, wherein performing the vector embedding comprises:
generating individual embedding vectors for each of a plurality of parsed features from a subject field and an issuer field of the digital certificate; and
concatenating the individual embedding vectors to form the test vector.

8. The method of claim 1, wherein classifying the digital certificate comprises identifying a plurality of k nearest reference vectors to the test vector in the vector data structure, and determining a classification based on a majority vote among the classifications of the k nearest reference vectors.

9. The method of claim 8, wherein the vector data structure comprises a vector index implemented using a similarity search engine for approximate nearest neighbor retrieval.

10. A network monitoring system for evaluating a digital certificate, comprising:
a computer-readable medium storing code that, when executed by a processor, causes the processor to:
receive the digital certificate from a network source;
extract text from the digital certificate;
perform a vector embedding for the extracted text using a pretrained transformer-based encoder to generate a test vector;
search a vector data structure using the test vector to identify a reference vector; and
classify the digital certificate as malicious or non-malicious based on the reference vector.

11. The system of claim 10, wherein the code for performing the vector embedding is executable by the processor to generate a single embedding vector from a subject string of the digital certificate.

12. The system of claim 10, wherein the code for performing the vector embedding is executable by the processor to concatenate a subject string and an issuer string of the digital certificate into an input string and generate an embedding vector from the input string.

13. The system of claim 10, wherein the code for performing the vector embedding is executable by the processor to generate separate embedding vectors for a subject string and an issuer string of the digital certificate and concatenate the separate embedding vectors to form the test vector.

14. The system of claim 10, wherein the code for performing the vector embedding is executable by the processor to generate individual embedding vectors for each of a plurality of parsed features from a subject field and an issuer field of the digital certificate and concatenate the individual embedding vectors to form the test vector.

15. The system of claim 10, wherein the code for classifying the digital certificate is executable by the processor to identify a plurality of k nearest reference vectors to the test vector in the vector data structure and determine a classification based on a majority vote among the classifications of the k nearest reference vectors.

16. The system of claim 15, wherein the vector data structure comprises a high-dimensional vector index implemented using a similarity search engine optimized for approximate nearest neighbor retrieval.

17. A non-transitory computer-readable medium storing executable instructions to:
receive a digital certificate from a network source;
extract text from the digital certificate;
perform a vector embedding for the extracted text using a pretrained transformer-based encoder to generate a test vector;
search a vector data structure using the test vector to identify a reference vector; and
classify the digital certificate as malicious or non-malicious based on the reference vector.

18. The computer-readable medium of claim 17, wherein the executable instructions to perform the vector embedding comprise instructions to generate a single embedding vector from a subject string of the digital certificate.

19. The computer-readable medium of claim 17, wherein the executable instructions to perform the vector embedding comprise instructions to concatenate a subject string and an issuer string of the digital certificate into an input string, and generate an embedding vector from the input string.

20. The computer-readable medium of claim 17, wherein the executable instructions to perform the vector embedding comprise instructions to generate one or more embedding vectors from one or more of a subject string, an issuer string, or parsed features of the digital certificate, and concatenate the one or more embedding vectors to form the test vector.
